(19) United States
(12) Patent Application Publication
(10) Pub. No.: US 2026/0196679 A1
(43) Pub. Date: Jul. 9, 2026

(54) RECHARGEABLE BATTERY

(71) Applicant: Samsung SDI Co., Ltd., Yongin-si (KR)

(72) Inventors: Jungah Yoon, Yongin-si (KR); Jongwoo Choi, Yongin-si (KR); Sang Gyu Kim, Yongin-si (KR); Chihoon Song, Yongin-si (KR); Jaehyeon Yun, Yongin-si (KR)

(73) Assignee: Samsung SDI Co., Ltd., Yongin-si (KR)

(21) Appl. No.: 19/011,270

(22) Filed: Jan. 6, 2025

(30) Foreign Application Priority Data
Apr. 18, 2024 (KR) 10-2024-0052359

(51) Int. Cl. H01M 50/533; H01M 10/04; H01M 50/105; H01M 50/54

(52) U.S. Cl. CPC H01M 50/533; H01M 10/049; H01M 50/105; H01M 50/54

(57) ABSTRACT

A rechargeable battery includes an electrode assembly including a separation layer, electrode plates stacked interposing the separation layer, and electrode tabs extending from each of the electrode plates and having a bent portion. An electrode lead connected to the electrode tabs has a bent portion, and a case accommodates the electrode assembly. The electrode tabs may include a lower side adjacent to the electrode assembly, and an upper side that is a remaining portion, which are parallel to each other. The electrode assembly, the electrode lead, and the case satisfy a first equation E=B*(0.73 to 0.77) and a second equation C=D*0.5. B indicates thickness of the electrode assembly, C indicates height of the electrode tabs, D indicates distance from a coupled portion of the case and the electrode lead to the electrode assembly, and E indicates distance between the bent portions.

### CROSS-REFERENCE TO RELATED APPLICATIONS

This present application claims priority to and the benefit under 35 U.S.C. § 119(a)-(d) of Korean Patent Application No. 10-2024-0052359, filed on Apr. 18, 2024, in the Korean Intellectual Property Office, the entire disclosure of which is incorporated herein by reference.

### FIELD

The present disclosure relates to a rechargeable battery.

### BACKGROUND

A typical pouch-type rechargeable battery has an electrode assembly located inside the battery case. It is common for a plurality of tabs extending from the electrode plate of the electrode assembly to be bent and welded to each other in a space between the electrode assembly and the battery case.

This electrode assembly has a plurality of tabs arranged to be bent as described above and is sealed by a battery case. Afterwards, a charge and discharge process is performed on the manufactured rechargeable battery, and as the electrode assembly is activated, shape abnormalities may occur in a number of tabs. Such shape abnormalities can cause short circuits, greatly reducing the operational safety of the rechargeable battery and causing defects.

### SUMMARY

One or more embodiments include providing a rechargeable battery capable of preventing shape abnormalities of a plurality of tabs.

However, aspects and features of the present disclosure are not limited to those described below, and other aspects and features not mentioned will be clearly understood by a person skilled in the art from the detailed description.

A rechargeable battery according to some embodiments may include an electrode assembly including a separation layer, a plurality of electrode plates stacked interposing the separation layer, and electrode tabs. Each electrode tab may extend from a respective one of the plurality of electrode plates and have a bent portion. An electrode lead connected to the electrode tabs may have a bent portion, and a case may accommodate the electrode assembly. The electrode tabs may include a lower side located adjacent to the electrode assembly and extending to the bent portion, and an upper side that is a remaining portion of the electrode tabs, which are disposed parallel to each other. The electrode assembly, the electrode lead, and the case may satisfy a first equation defining E=B*(0.73 to 0.77) and a second equation defining C=D*0.5, where B indicates a thickness of the electrode assembly, C indicates a height occupied by the electrode tab of the electrode assembly, D indicates a distance from a portion where the case and the electrode lead are coupled to each other to an end portion of the electrode assembly, and E indicates a distance from the bent portion in the electrode tab to the bent portion in the electrode lead.

The electrode assembly, the electrode lead, and the case may satisfy a third equation defining B=A−(0.4 mm to 0.5 mm) and a fourth equation defining D=(B*0.4)−0.74 (mm), where A indicates a thickness of the rechargeable battery and mm is millimeters.

In the electrode lead, a portion coupled to the electrode tabs and a portion coupled to the case may be disposed to be perpendicular to each other.

The plurality of electrode plates may include a positive electrode plate and a negative electrode plate.

The electrode tab may include a positive electrode tab and a negative electrode tab.

The electrode assembly may include an insulation member surrounding a portion of the electrode lead coupled to the case.

A thickness of the rechargeable battery may be in a range of 1.5 millimeters (mm) to 6.5 mm.

A thickness of the electrode assembly may be in a range of 1 millimeters (mm) to 6 mm.

According to one or more embodiments, a method of manufacturing a rechargeable battery includes disposing an electrode assembly in a case. The electrode assembly may include a separation layer, a plurality of electrode plates stacked interposing the separation layer, and electrode tabs. Each electrode tab may extend from a respective one of the plurality of electrode plates, and the electrode tabs have a bent portion. An electrode lead may be connected to the electrode tabs and may have a bent portion. The electrode tabs may comprise a lower side located adjacent to the electrode assembly and extending to the bent portion of the electrode tabs, and an upper side that is a remaining portion of the electrode tabs, which are disposed parallel to each other. The electrode assembly, the electrode lead, and the case may satisfy a first equation defining E=B*(0.73 to 0.77) and a second equation defining C=D*0.5. B indicates a thickness of the electrode assembly, C indicates a height occupied by the electrode tabs of the electrode assembly, D indicates a distance from a portion where the case and the electrode lead are coupled to each other to an end portion of the electrode assembly, and E indicates a distance from the bent portion in the electrode tabs to the bent portion in the electrode lead.

A rechargeable battery according to the present disclosure may be manufactured to satisfy the first equation through the fourth equation. Therefore, according to some embodiments, during the process of manufacturing the rechargeable battery, electrode tabs and electrode leads are not manufactured in arbitrary dimensions, but are manufactured with standardized dimensions in conjunction with the size of the electrode assembly and the case. Therefore, the rechargeable battery may be manufactured precisely according to the target design.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing a case of a rechargeable battery in an open state according to one or more embodiments.

FIG. 2 is a cross-sectional view showing the rechargeable battery of FIG. 1.

FIG. 3 is a simplified cross-sectional view of each member of the rechargeable battery of FIG. 2.

FIG. 4 is a graph showing optimal heights of a space between the case and electrode assembly with respect to the thickness of the electrode assembly according to some embodiments.

FIG. 5 is a CT image photographing a rechargeable battery manufactured by using equations defining relationships among dimensions according to some embodiments.

FIG. 6 is a CT image photographing a first electrode plate of a rechargeable battery manufactured by using the equations defining relationships among dimensions.

FIG. 7 is a CT image photographing a second electrode plate of a rechargeable battery manufactured by using the equations defining relationships among dimensions.

FIG. 8 is a CT image photographing a first electrode plate of a rechargeable battery manufactured without using the equations defining relationships among dimensions.

FIG. 9 is a CT image photographing a second electrode plate of a rechargeable battery manufactured without using the equations defining relationships among dimensions.

### DETAILED DESCRIPTION

Embodiments of the present disclosure will be described more fully hereinafter with reference to the accompanying drawings. As those skilled in the art would realize, the described embodiments may be modified in various different ways, all without departing from the spirit of the disclosure or scope of the claims. The drawings and description are to be regarded as illustrative in nature and not restrictive.

In addition, in the accompanying drawings, sizes or thicknesses of various components are exaggerated for brevity and clarity, and like numbers refer to like elements throughout. As used herein, the term “and/or” includes any one and all combinations of one or more of the associated listed items. In addition, it should be understood that when an element A is referred to as being “connected to” an element B, the element A can be directly connected to the element B, or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It should be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

In addition, terms related to a space, such as “beneath”, “below”, “lower”, “above”, “upper”, or the like, may be used for better understanding of elements or features shown in the drawing. It should be understood that such spatially relative terms are intended to encompass different orientations of the device in use or operation, in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both orientations of above and below.

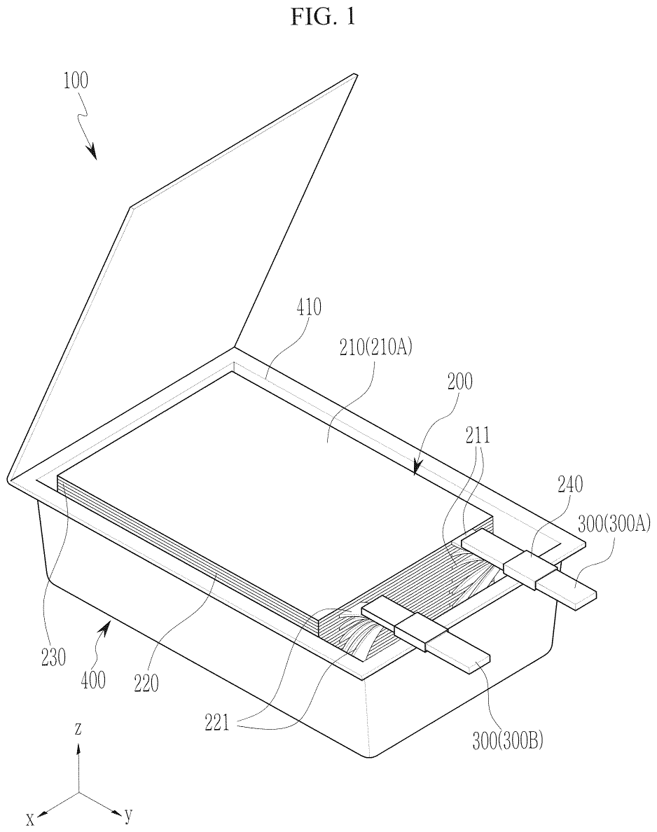

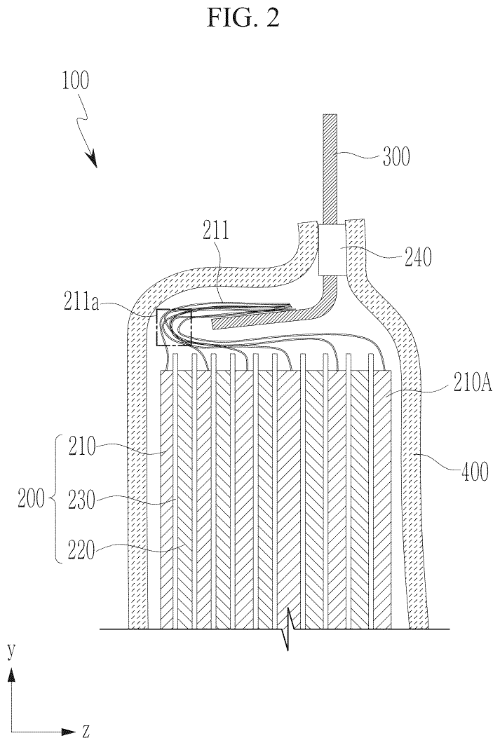

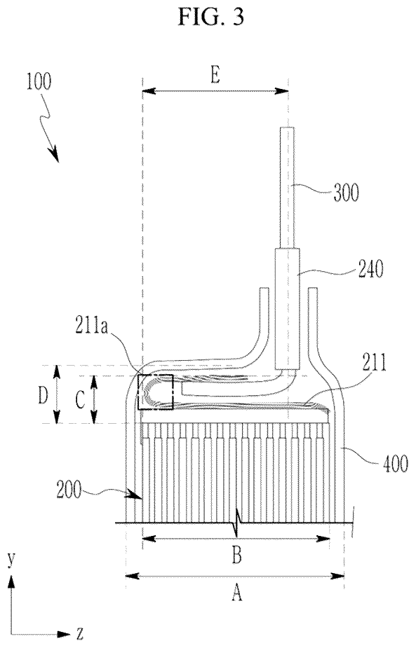

FIG. 1 is a perspective view showing a case of a rechargeable battery in an open state according to one or more embodiments. FIG. 2 is a cross-sectional view showing the rechargeable battery of FIG. 1. FIG. 3 is a simplified cross-sectional view of each member of the rechargeable battery of FIG. 2.

Referring to FIG. 1 to FIG. 3, a rechargeable battery 100 according to some embodiments may include an electrode assembly 200, an electrode lead 300 and a case 400.

The electrode assembly 200 may include a plurality of electrode plates 210 and 220 and a separation layer 230. In more detail, the plurality of electrode plates 210 and 220 may include a first electrode plate 210 and a second electrode plate 220.

The electrode assembly 200 may be in the form of a laminate including the first electrode plate 210, the second electrode plate 220, and the separator 230 being repeatedly wound or stacked.

For example, the electrode assembly 200 may be a stacked type, in which the electrode plates 210 and 220 are disposed to be stacked in multiple layers. Alternatively, the electrode assembly 200 may be of a repeatedly wound jelly-roll type. In the present disclosure, the electrode assembly 200 of the stacked type is illustrated and described as an exemplary embodiment but the description is not intended to be limited to the illustrated example.

In a typical manufacturing process of the electrode assembly 200 of the stacked type, a primary stack process and a secondary stack process are performed. In the primary stack process, full cathodes and full anodes may be stacked. The full cathodes may exclude a first electrode plate 210A, which is outermost among a plurality of first electrode plates 210. In addition, the full anodes may be the second electrode plates 220.

In the secondary stack process, a half cathode may be stacked on one side of at least one of the outermost sides, based on a stacking direction. The half cathode may be an outermost first electrode plate 210A among the first electrode plates 210.

FIG. 2 illustrates an exemplary embodiment of the electrode assembly 200 in which the half cathode is stacked on an outermost upper side of the electrode assembly 200. In alternate embodiments, the half cathode may be stacked on each of an outermost upper side and outermost both sides of the electrode assembly 200.

The full cathode and the full anode may be ones in which the active material is applied to both surfaces of a substrate, and the half cathode may be one in which the electrode plate layer is located on only one surface of a collector layer. The electrode plate layer may be an active material layer. Additional known details of the full cathode, the full anode, and the half cathode are not included herein.

The separation layer 230 may be interposed between each pair of the first electrode plate 210 and the second electrode plate 220. The separator 230 may prevent a short circuit of the first electrode plate 210 and the second electrode plate 220, and may allow movement of lithium ions. The separation layer 230 may be formed in a size relatively greater than the first electrode plate 210 or the second electrode plate 220.

The material of the separator 230 may be, for example, polyethylene, polypropylene, or a composite film of polyethylene and polypropylene, but is not limited thereto.

Such the separator 230 may be cut into unit lengths and disposed between the first electrode plate 210 and the second electrode plate 220. Alternatively, a single separator 230 in a ribbon shape may be disposed between pairs of the first electrode plate 210 and the second electrode plate 220 in a zigzag shape. Alternatively, the separator 230 may be installed to be wound in one direction between pairs of the first electrode plate 210 and the second electrode plate 220. The arrangement of the separation layer 230 is not limited to one particular form.

The electrode assembly 200 may include electrode tabs 211 and 221. The electrode tabs 211 and 221 may be formed to extend from each of the plurality of electrode plates 210 and 220 and to have a bent portion 211a.

For example, a central portion of the electrode tabs 211 and 221 may be bent. Therefore, shape of the electrode tabs 211 and 221 may approximate a U-shape or V-shape. The electrode tabs 211 and 221 may be located in a space between an upper end of the electrode assembly 200 and an upper side of the case 400, according to the orientation shown in FIG. 2.

As described above, the plurality of electrode plates 210 and 220 may include the first electrode plates 210 and the second electrode plates 220. The electrode tabs 211 and 221 described above may extend from each of the first electrode plates 210 and the second electrode plates 220, respectively.

The electrode tabs 211 extending from the first electrode plates 210 may be coupled to each other as shown in FIG. 2, for example. Similarly, the electrode tabs 221 extending from the second electrode plates 220 may be coupled to each other. The electrode tabs 221 are not also shown for clarity of the illustration.

For explanatory purposes, the electrode tab extending from each of the first electrode plates 210 is referred to as a first electrode tab 211, and the electrode tab extending from each of the second electrode plates 220 is referred to as a second electrode tab 221.

An electrode lead 300 may be connected to the electrode tabs 211 and to the electrode tabs 221. Specifically, electrode lead 300A may be connected to the first electrode tabs 211, and electrode lead 300B may be connected to the second electrode tabs 221. That is, the first electrode plates 210 and the second electrode plates 220 may be electrically connected to the outside of rechargeable battery 100 through the electrode leads 300A and 300B (generally referred to as electrode lead 300).

A portion of the electrode lead 300 coupled to the electrode tab 221 and a portion of the electrode lead 300 coupled to the case 400 may be approximately perpendicular to each other with a bend in between. The shape of the electrode lead 300 may be, for example, L-shaped or nearly L-shaped.

An insulation member 240 may surround the portion of the electrode lead 300 that couples to the case 400. The insulation member 240 may prevent the electrode lead 300 and the case 400 from being electrically conductive.

The case 400 may accommodate the electrode assembly 200. The electrode assembly 200 described above may be accommodated in the case 400 together with electrolyte.

The case 400 may be one of a pouch type, a cylindrical type, and a prismatic type according to different exemplary embodiments. The case 400 of the pouch type may be manufactured by bending an exterior material of a plate shape, and then pressing or drawing a surface, to have a recess (i.e., pouch) on the surface.

The electrode assembly 200 may be accommodated in the recess (not shown). A sealing portion 410 may be provided on the exterior circumference of the recess, and while the electrode assembly 200 is accommodated in the recess, the sealing portion 410 may be sealed through a method such as heat fusion.

The plurality of electrode plates 210 and 220 may include a positive electrode plate and a negative electrode plate. More specifically, the first electrode plates 210 described above may be used as the negative electrode plates, and the second electrode plates 220 may be used as the positive electrode plates, or vice versa.

In addition, the electrode tabs 211 and 221 described above may include a positive electrode tab 221 and a negative electrode tab 211. The negative electrode tabs 211 may be ones extending from the first electrode plates 210, and the positive electrode tabs 221 may be ones extending from the second electrode plates 220.

The electrode tabs 211 and 221 may include lower and upper sides. For example, the electrode tabs 211 shown in FIG. 2 each include a lower side located adjacent to the electrode assembly 200 and extending to the bent portion 211a, and an upper side that is a remaining portion. The upper side of the electrode tabs 211 are disposed parallel to each other as shown. Similarly, each of the electrode tabs 221 may include a lower side from the electrode assembly 200 to a bent portion and a remaining upper side. The rechargeable battery 100 with the exemplary shape of the electrode tabs 211 and 221 (i.e., with lower and upper sides as shown in FIG. 2, for example) may prevent the electrode assembly 200 from being pressed by the electrode tabs 211 and 221. In addition, the space occupied by the electrode tabs 211 and 221 within the case 400 may be minimized.

Exemplary dimensions of the electrode assembly 200, the electrode tabs 211 and 221, the electrode lead 300, and the case 400 required for manufacturing a rechargeable battery 100 according to some embodiments are described.

The electrode assembly 200, the electrode lead 300, and the case 400 included in a rechargeable battery 100 according to some embodiments may satisfy the following:

$$E = B * ( 0.73 to 0.77 ) \qquad [ EQ . 1 ]$$

$$C = D * 0.5 \qquad [ EQ . 2 ]$$

In EQs. 1 and 2, B is a thickness of the electrode assembly 200, C is a height occupied by the electrode tabs 211 and 221, D is a distance from a portion where the case 400 and the electrode lead 300 are coupled to each other to an end portion of the electrode assembly 200, and E is a distance from the bent portion in the electrode tabs 211 and 221 to the bent portion in the electrode lead 300.

In more detail, the thickness B of the electrode assembly 200 may be a distance from a right-side end portion to a left-side end portion, based on a z-axis direction as indicated in FIG. 3.

As also indicated in FIG. 3, a height C occupied by the electrode tab 211 may be a distance occupied within the case 400 by the electrode tab 211 along a y-axis direction.

As noted above, a portion of the case 400 may be coupled to the electrode lead 300. The distance D may be a distance value from a portion where the case 400 and the electrode lead 300 are coupled to each other to the electrode assembly 200 along the y-axis direction, as indicated in FIG. 3.

As noted above, the electrode tabs 211 may have a bent portion 211a and the electrode lead 300 may have a bent portion. The value E may be a distance value from the bent portion 221a of the electrode tabs 211 to the bent portion of the electrode lead 300 along the z-axis direction, as indicated in FIG. 3.

EQ. 1 defines the length and shape of the electrode tabs 211 and the electrode lead 300 with respect to the thickness of the electrode assembly 200. According to EQ. 1, it may be preferable that the distance E from the bent portion in the electrode tabs 211 and 221 (e.g., 211a) to the bent portion in the electrode lead 300 is included in a range of 73 percent (%) to 77% with respect to the thickness B of the electrode assembly 200, for example.

When the distance E from the bent portion in the electrode tabs 211 and 221 to the bent portion in the electrode lead 300 is generally 75% of the thickness B of the electrode assembly 200, the electrode tabs 211 and 221 on the lower side located adjacent to the electrode assembly 200 and the electrode tabs 211 and 221 on the upper side may be parallel to each other.

According to EQ. 2, it may be preferable that the height C occupied by the electrode tabs 211 is 50% of the distance D from the portion where the case 400 and the electrode lead 300 are coupled to each other to an end portion of the electrode assembly 200.

When the height C occupied by the electrode tabs 211 exceeds 50% of the distance D from the portion where the case 400 and the electrode lead 300 are coupled to each other to an end portion of the electrode assembly 200, the electrode tabs 211 may be deformed such that the electrode tabs 211 on the lower side located adjacent to the electrode assembly 200 and the electrode tabs 211 on the upper side are not parallel to each other. In addition, the space between the electrode assembly 200 and the case 400 may be excessively abundant.

To the contrary, when the height C occupied by the electrode tabs 211 is less than 50% of the distance D from the portion where the case 400 and the electrode lead 300 are coupled to each other to an end portion of the electrode assembly 200, the space within the case 400 may not be secured, such that the electrode plate may be pressed by the electrode tabs 211.

According to EQ. 1 and EQ. 2, the electrode tabs 211 disposed on the lower side located adjacent to the electrode assembly 200 and the electrode tabs 211 located on the upper side are parallel to each other.

According to some embodiments, the electrode assembly 200, the electrode lead 300, and the case 400 included in a rechargeable battery 100 may satisfy EQ. 3 and EQ. 4 shown below:

$$B = A - ( 0.4 mm to 0.5 mm ) \qquad [ EQ . 3 ]$$

$$D = ( B * 0.4 ) - 0.74 ( mm ) \qquad [ EQ . 4 ]$$

A may be a thickness of the rechargeable battery 100. The thickness A of the rechargeable battery 100 may be a distance from one exterior side of the case 400 to an opposite side exterior side along the z-axis direction, as indicated in FIG. 3.

According to EQ. 3, the thickness B of the electrode assembly 200 may be designed to be smaller than the thickness A of the rechargeable battery 100 by 0.4 millimeters (mm) to 0.5 mm. The thickness B of the electrode assembly 200 may be a value after performing the formation process (charge and discharge process). In addition, the thickness B of the electrode assembly 200 may be predetermined in consideration of swelling that may occur in the rechargeable battery 100.

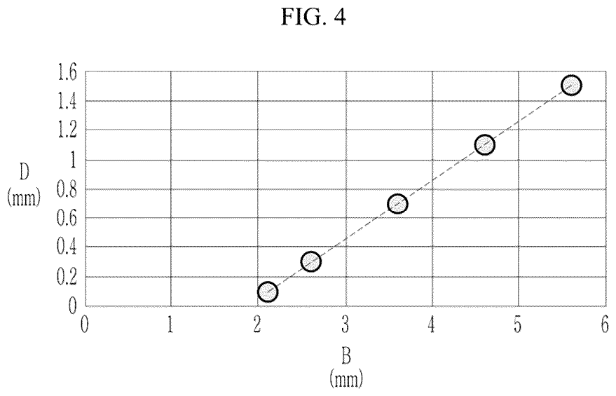

EQ. 4 may be obtained by manufacturing the case 400 in various sizes with respect to the electrode assembly 200, and then determining an optimal dimension of the case 400 with respect to the thickness of the electrode assembly 200. Referring to FIG. 4, the relationship between B and D may be obtained through repetitive experiments, and EQ. 4 may be a relation equation representing the co-relationship of B and D.

That is, the height of the space in which the electrode tabs 211 are located in the case 400 in relation to the thickness of the electrode assembly 200 may be defined by EQ. 4. Therefore, when manufacturing the rechargeable battery 100 by using EQ. 4, standardization of the size of the case 400 may be performed.

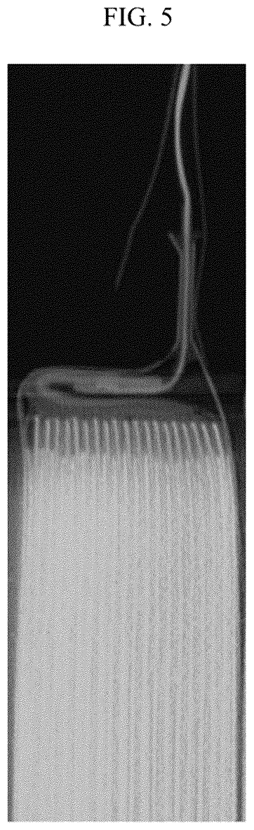

FIG. 5 is a CT image photographing an exemplary rechargeable battery 100 manufactured according to EQs. 1-4. By using EQs. 1-4 in the process of manufacturing a rechargeable battery 100 according to some embodiments, standardization may be performed, and, accordingly, the rechargeable battery 100 may be manufactured to be appropriate for the target design.

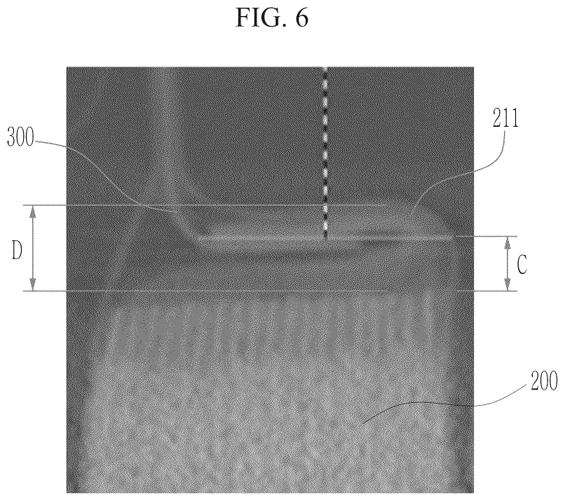

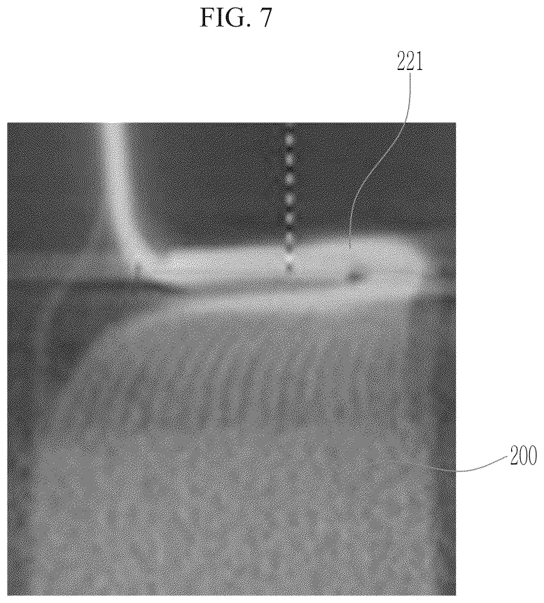

FIG. 6 is a CT image photographing the first electrode plate of a rechargeable battery 100 manufactured by using EQs. 1-4 according to some embodiments. FIG. 7 is a CT image photographing the second electrode plate of the rechargeable battery 100 manufactured by using EQs. 1-4.

As indicated in FIGS. 6 and 7, the electrode tabs 221 of the rechargeable battery 100 on the lower side located adjacent to the electrode assembly 200 and the electrode tabs 221 on the upper side are disposed parallel to each other. In addition, the height C occupied by the electrode tabs 221 is minimized. In addition, the distance D from the end portion of the electrode assembly 200 to the case 400 is also minimized.

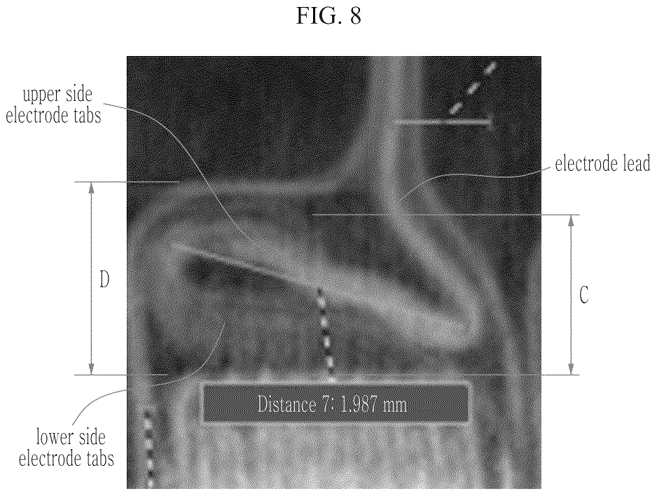

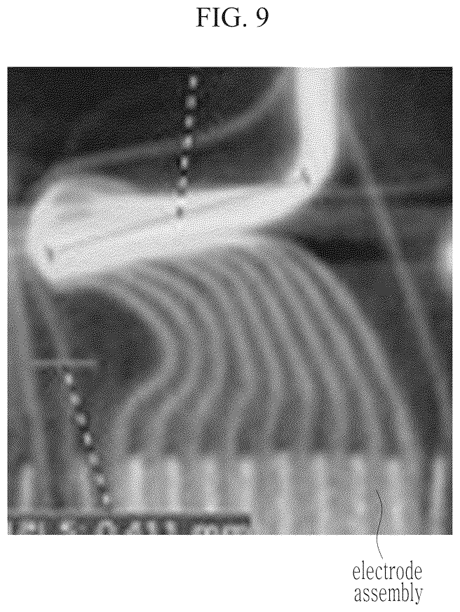

FIG. 8 is a CT image photographing the first electrode plate of a rechargeable battery manufactured without conforming to EQs. 1-4. FIG. 9 is a CT image photographing the second electrode plate of the rechargeable battery manufactured without using EQs. 1-4.

As indicated in FIGS. 8 and 9, in the rechargeable battery according to the comparative example, the electrode tabs on the upper side are excessively bent compared to the electrode tabs on the lower side located adjacent to the electrode assembly. In addition, the electrode lead of the rechargeable battery has a deformed shape, which is different from the “L” shape in FIG. 6, for example.

In addition, deformation occurs as the first electrode plate of the electrode assembly is pressed by the electrode tabs. In addition, the height C occupied by the electrode tabs and the distance D from the end portion of the electrode assembly to the case is large relative to the values in FIG. 6, for example. Additionally, the distance from the bent portion in the electrode tab to the bent portion in the electrode lead for the rechargeable battery in FIG. 8 is 90.5% with respect to the thickness B of the electrode assembly. In addition, the distance from the bent portion in the electrode tab to the bent portion in the electrode lead of FIG. 9 is 81.4% with respect to the thickness B of the electrode assembly.

As described above, unlike a rechargeable battery 100 according to embodiments described with reference to FIGS. 1-7, in FIG. 8 and FIG. 9, the distance E from the bent portion in the electrode tab to the bent portion in the electrode lead is out of the range of 73% to 77% with respect to the thickness B of the electrode assembly.

On the other hand, a rechargeable battery 100 according to embodiments detailed herein satisfies EQs. 1-4. Therefore, according to processes of manufacturing a rechargeable battery according to one or more embodiments, electrode tabs and electrode leads are manufactured with standardized dimensions in conjunction with the size of the electrode assembly and the case. Therefore, a rechargeable battery 100 according to the one or more embodiments may be manufactured precisely according to a target design.

It is to be understood that the disclosure is not limited to only the embodiments detailed herein, but is also intended to cover various modifications and equivalent arrangements included within the spirit of the present disclosure and the equivalent scope of the appended claims.

What is claimed is:

1. A rechargeable battery, comprising:
an electrode assembly comprising a separation layer, a plurality of electrode plates stacked interposing the separation layer, and electrode tabs, each electrode tab extending from a respective one of the plurality of electrode plates, the electrode tabs having a bent portion;
an electrode lead connected to the electrode tabs, and having a bent portion; and
a case configured to accommodate the electrode assembly,
wherein the electrode tabs comprise a lower side located adjacent to the electrode assembly and extending to the bent portion of the electrode tabs, and an upper side that is a remaining portion of the electrode tabs, which are disposed parallel to each other, and
wherein the electrode assembly, the electrode lead, and the case satisfy a first equation defining E=B*(0.73 to 0.77) and a second equation defining C=D*0.5, where B indicates a thickness of the electrode assembly, C indicates a height occupied by the electrode tabs of the electrode assembly, D indicates a distance from a portion where the case and the electrode lead are coupled to each other to an end portion of the electrode assembly, and E indicates a distance from the bent portion in the electrode tabs to the bent portion in the electrode lead.

2. The rechargeable battery of claim 1, wherein the electrode assembly, the electrode lead, and the case satisfy a third equation defining B=A−(0.4 mm to 0.5 mm) and a fourth equation defining D=(B*0.4)−0.74 (mm), where A indicates a thickness of the rechargeable battery and mm is millimeters.

3. The rechargeable battery of claim 1, wherein, in the electrode lead, a portion coupled to the electrode tabs and a portion coupled to the case are disposed to be perpendicular to each other.

4. The rechargeable battery of claim 1, wherein the plurality of electrode plates comprises a positive electrode plate and a negative electrode plate.

5. The rechargeable battery of claim 1, wherein the electrode tabs comprise a positive electrode tab and a negative electrode tab.

6. The rechargeable battery of claim 1, wherein the electrode assembly comprises an insulation member surrounding a portion of the electrode lead coupled to the case.

7. The rechargeable battery of claim 1, wherein a thickness of the rechargeable battery is in a range of 1.5 millimeters (mm) to 6.5 mm.

8. The rechargeable battery of claim 1, wherein a thickness of the electrode assembly is in a range of 1 millimeters (mm) to 6 mm.

9. A method of manufacturing a rechargeable battery, the method comprising:
disposing an electrode assembly in a case, the electrode assembly comprising a separation layer, a plurality of electrode plates stacked interposing the separation layer, and electrode tabs, each electrode tab extending from a respective one of the plurality of electrode plates, the electrode tabs having a bent portion,
wherein an electrode lead is connected to the electrode tabs, the electrode lead having a bent portion and
wherein the electrode tabs comprise a lower side located adjacent to the electrode assembly and extending to the bent portion of the electrode tabs, and an upper side that is a remaining portion of the electrode tabs, which are disposed parallel to each other, and
wherein the electrode assembly, the electrode lead, and the case satisfy a first equation defining E=B*(0.73 to 0.77) and a second equation defining C=D*0.5, where B indicates a thickness of the electrode assembly, C indicates a height occupied by the electrode tabs of the electrode assembly, D indicates a distance from a portion where the case and the electrode lead are coupled to each other to an end portion of the electrode assembly, and E indicates a distance from the bent portion in the electrode tabs to the bent portion in the electrode lead.
